(19) United States
(12) Patent Application Publication
(10) Pub. No.: US 2026/0009216 A1
(43) Pub. Date: Jan. 8, 2026

(54) SEWER CLEANOUT CAP

(71) Applicants: BGA Technology LLC, Holbrook, NY (US); PIPELOGIX LMS, INC., Long Beach, NY (US)

(72) Inventors: Saikumar Padmanabhan, Selden, NY (US); Srinivas Sridhar, Flushing, NY (US); Eliot Bloom, West Islip, NY (US); Michael Bloom, Hoboken, NJ (US); Thomas W. Alfano, East Rockaway, NY (US)

(21) Appl. No.: 19/328,352

(22) Filed: Sep. 15, 2025

Related U.S. Application Data
(63) Continuation-in-part of application No. 18/195,556, filed on May 10, 2023.
(60) Provisional application No. 63/340,574, filed on May 11, 2022.

(51) Int. Cl. E03F 3/04; E03F 5/02; E03F 7/00; F16L 55/115

(52) U.S. Cl. CPC E03F 3/04; E03F 5/02; E03F 7/00; E03F 2201/40; F16L 55/1157

(57) ABSTRACT

A sewer cleanout cap includes: a body portion configured to be disposed on a sewer drain cleanout; a window plug removably coupled to the body portion, the window plug configured to enable a user to check sewer drainage; at least one wireless identification tag disposed on at least one of the body portion, the window plug, or a site glass of the window plug, the at least one wireless identification tag configured to transmit a return signal when energized; and at least one clamp assembly coupled to the body portion and configured to releasably secure the body portion to the sewer drain cleanout.

### CROSS-REFERENCE TO RELATED APPLICATION/CLAIM OF PRIORITY

This application is a continuation of part of, claims the benefit of, and priority to U.S. application Ser. No. 18/195,556, filed on May 10, 2023, and U.S. Provisional Patent Application No. 63/340,574, filed on May 11, 2022, the entire contents of which are hereby incorporated herein by reference.

### TECHNICAL FIELD

The present disclosure relates to piping systems such as sewer systems. More specifically, the present disclosure relates to smart cleanout caps providing instant access to information pertaining to piping systems.

### BACKGROUND

Cleanout caps enable access to internal conduits of pipes, for example, of sewer systems. Since these pipes are typically formed of opaque materials, the cleanout cap must be removed to determine if these conduits need to be cleaned. Moreover, the maintenance history of the conduits is often not readily available. Thus, even if a sewer system does not need cleaning, the cleanout cap would be required to be removed to make such a determination. This process can be tedious and inefficient. Further, when removing a cleanout cap, raw sewage can spill on the ground, creating an environmental issue.

### SUMMARY

The present disclosure provides a sewer cleanout cap that can help make cleaning of sewer systems more efficient and more environmentally friendly.

In an aspect, a sewer cleanout cap includes a body portion configured to be disposed on a sewer drain cleanout, a window plug removably coupled to the body portion and configured to enable a user to check sewer drainage, at least one wireless identification tag disposed on at least one of the body portion, the window plug, or a site glass of the window plug, the wireless identification tag configured to transmit a return signal when energized, and at least one clamp assembly coupled to the body portion and configured to releasably secure the body portion to the sewer drain cleanout.

In an aspect of the present disclosure, the at least one wireless identification tag can include a radio frequency identification tag, a near field communication tag, or a combination of a radio frequency identification tag and a near field communication tag.

In an aspect of the present disclosure, the body portion can include at least two fingers configured to engage the at least one clamp assembly.

In an aspect of the present disclosure, the at least one clamp assembly can include a first toggle clamp and a second toggle clamp and can further include a strap extending between the first toggle clamp and the second toggle clamp to apply compressive force across the body portion.

In an aspect of the present disclosure, each of the first toggle clamp and the second toggle clamp can include a pivoting handle lever connected to one of the at least two fingers.

In an aspect of the present disclosure, the sewer cleanout cap can include a gasket positioned between the body portion and the sewer drain cleanout.

In an aspect of the present disclosure, actuation of the pivoting handle lever to a locked position can be configured to compress the gasket to form a watertight seal.

In an aspect of the present disclosure, the sewer cleanout cap can include a gasket positioned between the body portion and the sewer drain cleanout to form a seal when the body portion is secured by the at least one clamp assembly or when the body portion is secured by an alternative attachment mechanism selected from threaded engagement, snap-fit engagement, friction-fit engagement, or adhesive bonding.

In an aspect of the present disclosure, the window plug can be removable from the body portion and replaceable with a vacuum adapter configured to couple to a vacuum hose for extracting material from the sewer drain cleanout.

In an aspect of the present disclosure, the body portion can be configured to support the vacuum adapter without removal of the body portion from the sewer drain cleanout.

In an aspect of the present disclosure, at least one of the RFID tag or the NFC tag can store a unique identifier enabling access to information relating to the sewer drain cleanout.

In an aspect of the present disclosure, the information relating to the sewer drain cleanout can include an installation date of the sewer cleanout cap, a cleanout and maintenance history, and/or a location.

In an aspect of the present disclosure, the body portion can be comprised of cast iron.

In an aspect of the present disclosure, the site glass can be configured to enable visibility and/or access into the sewer drain cleanout.

In an aspect, a computer-implemented method for using a sewer cleanout cap includes generating an energizing signal for a wireless identification tag, the wireless identification tag disposed on a body portion of the sewer cleanout cap, wherein the sewer cleanout cap is coupled to a sewer drain cleanout, receiving a return signal from the wireless identification tag by a wireless identification tag reader, and determining a maintenance action for a sewer drain cleanout based on the return signal.

In an aspect of the present disclosure, the wireless identification tag can store a unique identifier enabling access to information relating to a sewer drain cleanout.

In an aspect of the present disclosure, the information relating to the sewer drain cleanout can include an installation date of the sewer cleanout cap, a cleanout and maintenance history, and/or a location.

In an aspect of the present disclosure, the method can include reprogramming the unique identifier of the wireless identification tag.

In an aspect of the present disclosure, the method can include transmitting information to a display of the wireless identification tag reader to display information relating to the wireless identification tag and modifying the displayed information via the wireless identification tag reader.

In an aspect of the present disclosure, the wireless identification tag reader can be a mobile device. In an aspect, a sewer cleanout cap includes a body portion configured to be disposed on a sewer drain cleanout, a window plug removably coupled to the body portion and configured to enable a user to check sewer drainage, at least one wireless identification tag disposed on at least one of the body portion, the window plug, or a site glass of the window plug, the wireless identification tag configured to transmit a return signal when energized, and at least one clamp assembly coupled to the body portion and configured to releasably secure the body portion to the sewer drain cleanout.

In an aspect of the present disclosure, the at least one wireless identification tag can include a radio frequency identification tag, a near field communication tag, or a combination of a radio frequency identification tag and a near field communication tag.

In an aspect of the present disclosure, the body portion can include at least two fingers configured to engage the at least one clamp assembly.

In an aspect of the present disclosure, the at least one clamp assembly can include a first toggle clamp and a second toggle clamp and can further include a strap extending between the first toggle clamp and the second toggle clamp to apply compressive force across the body portion.

In an aspect of the present disclosure, each of the first toggle clamp and the second toggle clamp can include a pivoting handle lever connected to one of the at least two fingers.

In an aspect of the present disclosure, the sewer cleanout cap can include a gasket positioned between the body portion and the sewer drain cleanout.

In an aspect of the present disclosure, actuation of the pivoting handle lever to a locked position can be configured to compress the gasket to form a watertight seal.

In an aspect of the present disclosure, the sewer cleanout cap can include a gasket positioned between the body portion and the sewer drain cleanout to form a seal when the body portion is secured by the at least one clamp assembly or when the body portion is secured by an alternative attachment mechanism selected from threaded engagement, snap-fit engagement, friction-fit engagement, or adhesive bonding.

In an aspect of the present disclosure, the window plug can be removable from the body portion and replaceable with a vacuum adapter configured to couple to a vacuum hose for extracting material from the sewer drain cleanout.

In an aspect of the present disclosure, the body portion can be configured to support the vacuum adapter without removal of the body portion from the sewer drain cleanout.

In an aspect of the present disclosure, at least one of the RFID tag or the NFC tag can store a unique identifier enabling access to information relating to the sewer drain cleanout.

In an aspect of the present disclosure, the information relating to the sewer drain cleanout can include an installation date of the sewer cleanout cap, a cleanout and maintenance history, and/or a location.

In an aspect of the present disclosure, the body portion can be comprised of cast iron.

In an aspect of the present disclosure, the site glass can be configured to enable visibility and/or access into the sewer drain cleanout.

In an aspect, a computer-implemented method for using a sewer cleanout cap includes generating an energizing signal for a wireless identification tag, the wireless identification tag disposed on a body portion of the sewer cleanout cap, wherein the sewer cleanout cap is coupled to a sewer drain cleanout, receiving a return signal from the wireless identification tag by a wireless identification tag reader, and determining a maintenance action for a sewer drain cleanout based on the return signal.

In an aspect of the present disclosure, the wireless identification tag can store a unique identifier enabling access to information relating to a sewer drain cleanout.

In an aspect of the present disclosure, the information relating to the sewer drain cleanout can include an installation date of the sewer cleanout cap, a cleanout and maintenance history, and/or a location.

In an aspect of the present disclosure, the method can include reprogramming the unique identifier of the wireless identification tag.

In an aspect of the present disclosure, the method can include transmitting information to a display of the wireless identification tag reader to display information relating to the wireless identification tag and modifying the displayed information via the wireless identification tag reader.

In an aspect of the present disclosure, the wireless identification tag reader can be a mobile device.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a diagram illustrating a sewer cleanout cap system including an RFID reader and an RFID tag in accordance with the disclosure;

FIG. 2 is a front perspective view of a sewer cleanout cap of the sewer cleanout cap system of FIG. 1 in accordance with the disclosure;

FIG. 3 is a perspective view, with parts separated, of the sewer cleanout cap of FIG. 2 in accordance with the disclosure;

FIG. 4 is a side perspective view of a window plug of the sewer cleanout cap of FIG. 3 in accordance with the disclosure;

FIG. 5 is a diagram illustrating the RFID reader shown in FIG. 1 in accordance with the disclosure;

FIG. 6 is a diagram of a controller of the RFID reader shown in FIG. 5 in accordance with the disclosure;

FIG. 7 is functional block diagram of a method of using a sewer cleanout cap in accordance with the disclosure;

FIG. 8 is a diagram illustrating another example embodiment of a sewer cleanout cap, in accordance with the disclosure;

FIG. 9 is a perspective view, with parts separated, of the sewer cleanout cap of FIG. 8, in accordance with the disclosure; and

FIG. 10 is a side perspective view of two sewer cleanout caps of FIG. 8 mounted to a sewer line, in accordance with the disclosure.

Further details and exemplary aspects of the disclosure are described in more detail below with reference to the appended figures. Any of the above aspects and aspects of the disclosure can be combined without departing from the scope of the disclosure.

### DETAILED DESCRIPTION

Aspects of the present disclosure are described in detail with reference to the drawings wherein like reference numerals identify similar or identical elements.

In general, the present disclosure relates to a sewer clean out cap. More specifically, the present disclosure relates to a sewer cleanout cap with a window plug and a radio-frequency identification (RFID) tag.

The phrases “in an aspect,” “in aspects,” “in various aspects,” “in some aspects,” or “in other aspects” can each refer to one or more of the same or different aspects in accordance with the present disclosure.

Although the present disclosure will be described in terms of specific aspects, it will be readily apparent to those skilled in this art that various modifications, rearrangements, and substitutions can be made without departing from the spirit of the present disclosure. The scope of the present disclosure is defined by the claims appended hereto. For purposes of promoting an understanding of the principles of the present disclosure, reference will now be made to exemplary aspects illustrated in the drawings, and specific language will be used to describe the same.

Radio-frequency identification (RFID) tags provide real-time data about products with minimal human intervention. RFID tags are advantageous in tough environments because they can withstand exposure to humidity, chemicals, and high temperature fluctuations unlike traditional barcodes. RFID tags are employed in sewer cleanout systems of this disclosure to provide real-time maintenance data of the disclosed sewer systems.

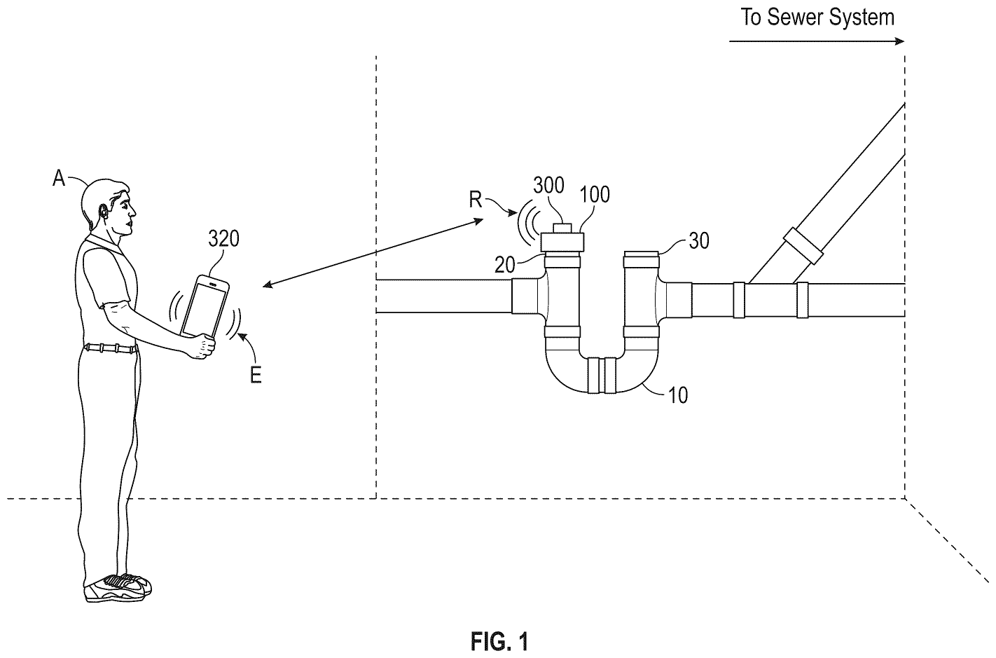

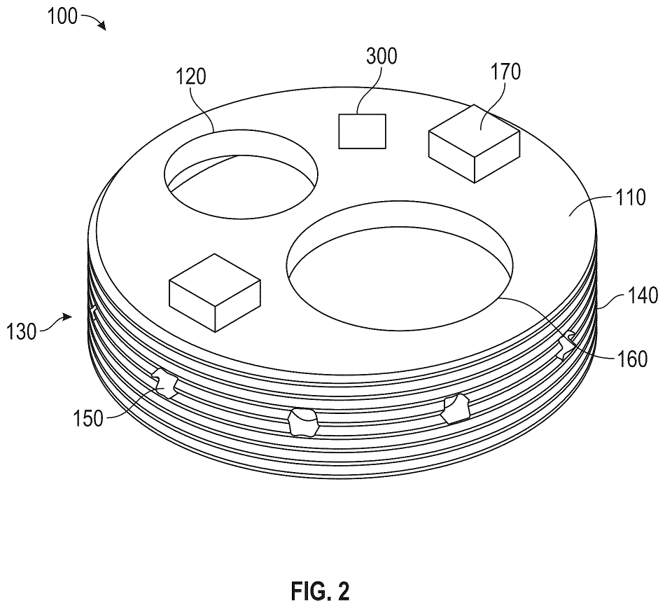

Referring to FIG. 1, a sewer cleanout cap system of this disclosure includes an RFID tag 300 and an RFID reader 320. The RFID tag 300 is configured to interact with an RFID reader 320, which can be controlled by a user A. Referring to FIG. 2, the sewer cleanout cap system includes a sewer cleanout cap 100 containing the RFID tag 300. The sewer cleanout cap 100 secures to a sewer drain cleanout (e.g., “trap”) 10. The sewer cleanout cap 100 additionally contains a body portion 110 and a window plug 200. The RFID tag 300 is configured to transmit a return signal R when energized.

The body portion 110 of the sewer cleanout cap 100 is generally made from the same/similar materials as the sewer drain cleanout 10. The body portion 110 can be made from metals such as cast iron, plastic, composites, and/or alternative durable materials. The body portion 110 can be treated with a corrosion-resistant coating to prevent rusting, such as plasma electrolytic oxidation, chromate conversion coating, painting, or a powder coating. While illustrated with a circular shape, the body portion 110 can include any suitable shape. The body portion 110 supports RFID tag 300 thereon and can include threads 140 (or ribs) formed in an outer rim 130 to enable secure attachment and/or removal from the sewer drain cleanout 10. It is contemplated that the body portion 110 can be secured to sewer drain cleanout 10 by any suitable attachment technique (e.g., snap-fit, friction-fit, fastening, adhesion, etc.). In aspects, the body portion 110 can be secured to the sewer drain cleanout 10 by adding a sealant, for example wax, around the outer rim 130 for providing a watertight seal.

The body portion 110 can include one or more pegs 170 to aid the user A in moving the sewer cleanout cap 100 into or out of sewer drain cleanout 10. For example, the user can hammer the peg 170 to move the sewer cleanout cap 100 into the sewer drain cleanout 10. The outer rim 130 can include one or more holes 150 disposed on outer rim 130. The RFID tag 300 is disposed on the body portion 110 of the sewer cleanout cap 100. Although peg 170 is shown as substantially square, any suitable shape can be used, for example, semicircular.

The sewer drain cleanout 10 can be a U-shaped trap, although the sewer drain cleanout 10 can include any suitable shape. The sewer cleanout cap 100 can be affixed to a first end 20 and/or a second end 30, or any alternative portion of the sewer drain cleanout 10 that is suitable.

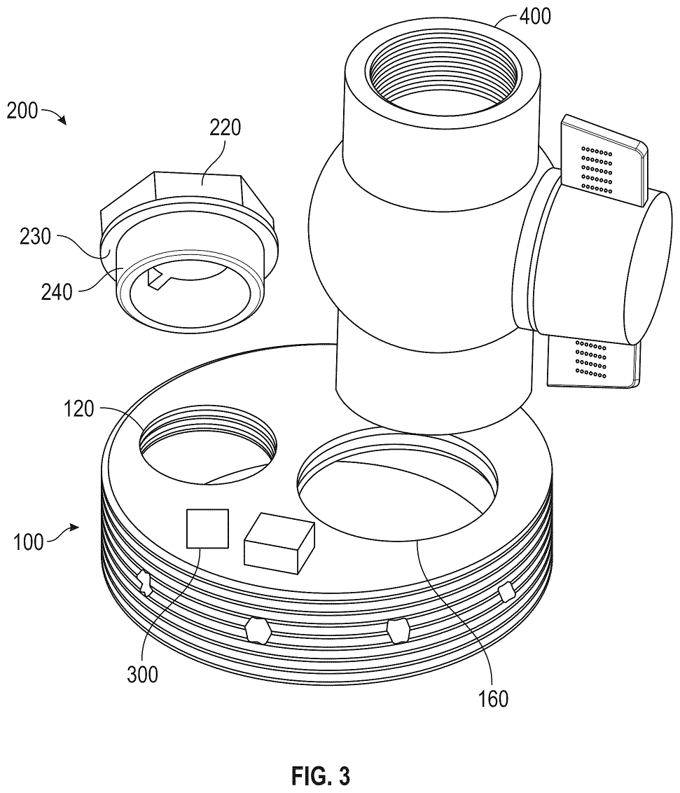

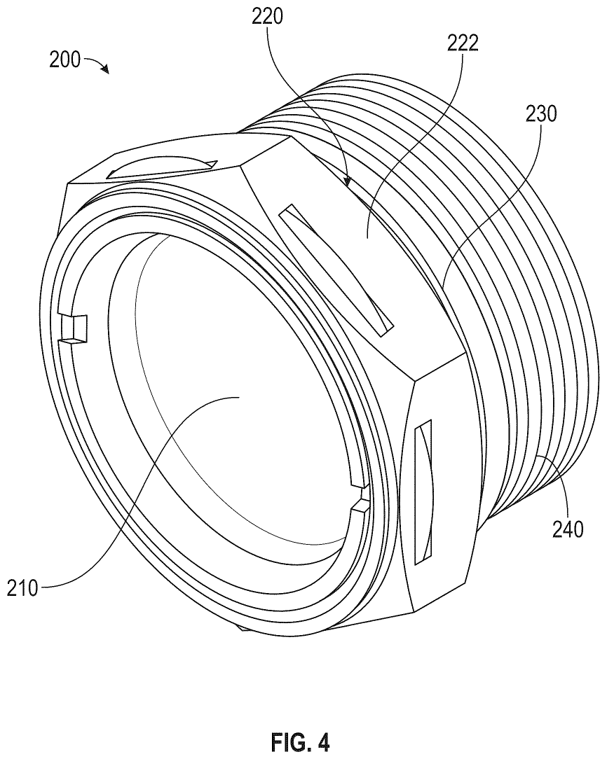

Referring to FIGS. 2-3, the body portion 110 of the sewer cleanout cap 100 defines an opening 120 for supporting the window plug 200 therein. The window plug 200 is configured to enable the user A to check sewer drainage behind the sewer cleanout cap 100. The body portion 110 of the sewer cleanout cap 100 can additionally define an opening 160 to which a valve 400 can be installed. In aspects, the window plug 200 can be disposed at the distal end of the valve 400. Upon opening the valve 400, excess fluid can be drained from the trap or a clogged pipe, or if the window plug 200 is disposed on the end of the valve 400, the user can actuate the valve 400 to check sewer drainage behind the sewer cleanout cap 100. Valve 400 can be any mechanism capable of permitting egress of fluid, such as a ball valve or a knife valve. It is contemplated that the body portion 110 of the sewer cleanout cap 100 can only have opening 160. The valve 400 can be secured to the opening 160, for example, by threading, snap-fit, friction-fit, or any other suitable means.

The window plug 200 generally includes a window 210, a handle portion 220, a gasket 230 and threads 240 (FIG. 3). The opening 120 can be threaded and configured to receive threads 240 of the window plug 200. The threads 240 are located behind the handle portion 220 to enable secure attachment to and/or removal from the body portion 110. While the window plug 200 is illustrated as being removably coupled to the body portion 110, the window plug 200 and body portion 110 can be affixed by any suitable securement technique. For example, the window plug 200 and body portion 110 can be joined by mechanical fasteners such as nut and bolt attachments or can be welded together.

The window 210 of window plug 200 is transparent to enable visibility into the sewer drain cleanout 10. For example, the user A can review sewage status such as clogs without removing the sewer cleanout cap 100 thereby preventing raw sewage from spilling out. The window 210 is removable to enable access into the sewer drain cleanout 10 during maintenance when the sewer cleanout cap 100 cannot be removed. For example, the window 210 can be removed and a drain snake, camera, hose or other device can be inserted through the opening 120. The window 210 can be made from materials such as glass, plastic, composite, and/or roto-molded materials. To ensure durability, any material in the window 210 can be shatterproof or impact resistant. The handle portion 220 is formed around the window 210 and includes edges 222 for the user A to grip onto during maintenance. While illustrated in a hexagonal shape, the handle portion 220 can include any suitable alternative shape. For example, the handle portion 220 can be shaped to fit snugly with a specific shaped wrench or alternative tool to enable ease of removal of the window plug 200. The handle portion 220 can be made from the same/similar material as the body portion 110. The handle portion 220 can be made from metals such as cast iron, plastic, and/or composites. A gasket 230 is located in a space between the handle portion 220 and the sewer drain cleanout 10 to seal cavities and prevent leakage. The gasket 230 can be flexible and made from paper, rubber, silicone, metal, cork, felt, neoprene, nitrile rubber, fiberglass, plastic polymer, and/or the like.

Now referring back to FIG. 1, the RFID tag 300 is disposed on the body portion 110 of the sewer cleanout cap 100. The RFID tag 300 is generally affixed to an outer surface and/or edge of the body portion 110. While the RFID tag 300 can be adhered to any suitable surface of the sewer cleanout cap 100, placement is generally chosen on an outer surface of the body portion 110 to enable accessibility into the sewer drain cleanout 10 and prevent damage due to exposure from raw sewage. The RFID tag 300 can be adhered to the body portion 110 by any suitable method, including film or foam adhesive, epoxy screws/rivets, or embedding methods. For example, an epoxy bonding compound can be used on the RFID tag 300 to ensure strong adherence to the body portion 110, especially when made of metal.

The RFID tag 300 is configured to interact with the RFID reader 320, which generates an energizing signal E for the RFID tag 300. Once energized, the RFID tag 300 is configured to transmit the return signal R. The RFID tag 300 can be a passive RFID system or an active RFID system. Generally, passive RFID systems are used, which do not require a power source or transmitter and therefore are cheaper, smaller, and easier to manufacture than active RFID tags. The RFID tag 300 can operate in low frequency (LF), high frequency (HF), or ultra-high frequency (UHF) bands. LF or HF bands can be used. The LF band covers frequencies from approximately 30 kHz to 300 kHz. The HF band cover frequencies from approximately 3 to 30 MHz and is more sensitive to interference.

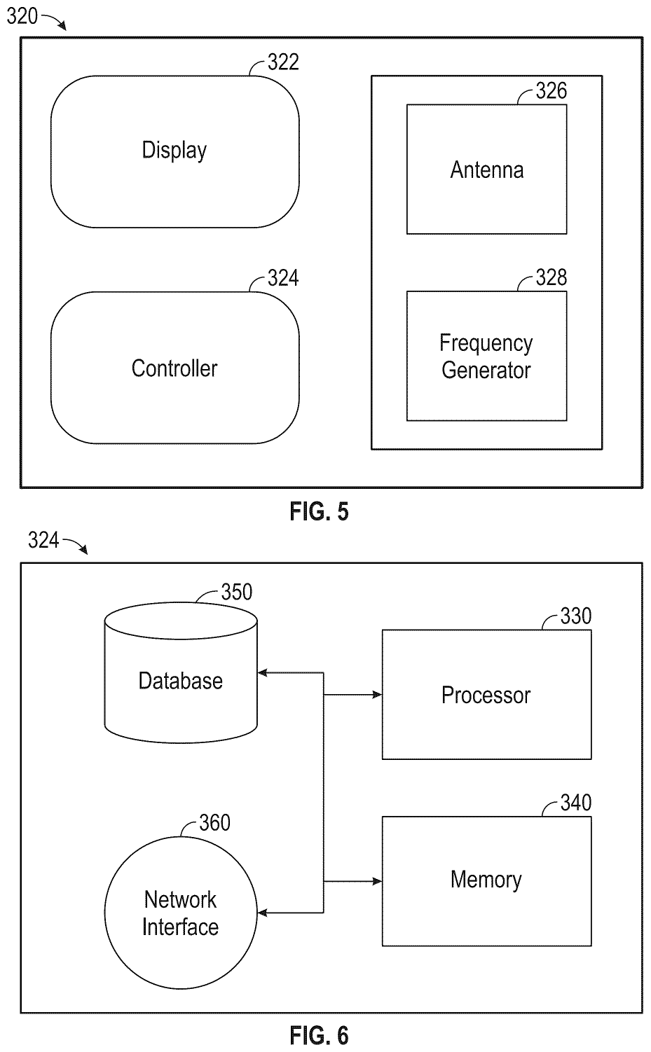

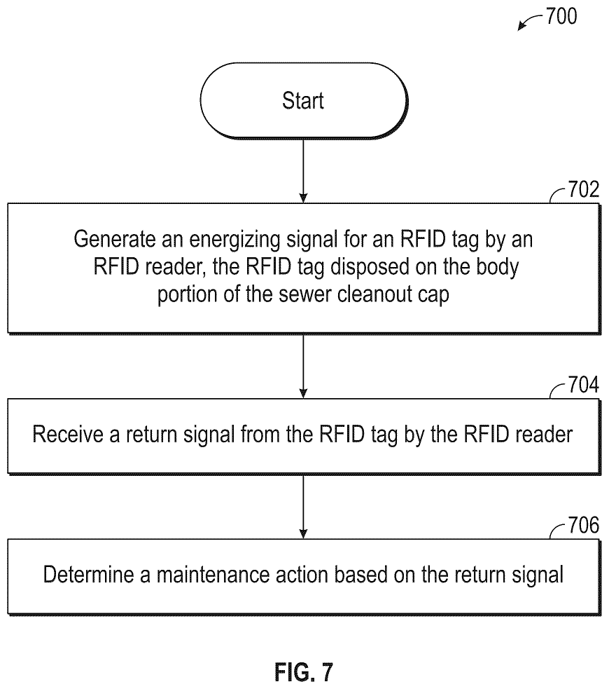

Now referring to FIGS. 5-6, the RFID reader 320 includes a display 322, a controller 324, an antenna 326 and a frequency generator 328. The display 322 can display information relating to the sewer drain cleanout 10. The controller 324 manages interactions between RFID products including reading data, transmitting data, and managing data between any system components. The antenna 326 sends a radio frequency signal to the RFID tag 300 and receives the return signal R from the RFID tag 300, including the UID. The frequency generator 328 generates the corresponding frequency of the signals generated.

With further reference to FIG. 6, the controller 324 generally includes a processor 330, a memory 340, a database 350, and/or a network interface 360. The processor 330 is connected to the memory 340, which is a computer-readable storage medium or memory.

In aspects of the disclosure, the processor 330 can be another type of processor such as a digital signal processor, a microprocessor, an ASIC, a graphics processing unit (GPU), a field-programmable gate array (FPGA), or a central processing unit (CPU).

The memory 340 stores data relating to the sewer drain cleanout 10 and can be a volatile type of memory, e.g., random access memory (RAM), or a non-volatile type of memory, e.g., flash media, disk media, etc. In some aspects of the disclosure, the memory 340 can be separate from the RFID reader 320 and can communicate with the processor 330 through communication buses of a circuit board and/or through communication cables such as serial ATA cables or other types of cables. The memory 340 includes computer-readable instructions that are executable by the processor 330 to operate the RFID reader 320. The database 350 can be used as a storage device for storing/retrieving information relating to the sewer drain cleanout 10, which is keyed by the UID of the RFID 300.

In other aspects of the disclosure, the RFID reader 320 can include the network interface 360 to communicate with other devices or a server. The network interface 360 can also be accomplished in systems that have weights implemented as memristors, chemically, or other inference calculations, as opposed to processors. The disclosed processes can run on the RFID reader 320 or on a user device, including, for example, on a mobile device, an IoT device, or a server system. The user A can be able to review sewer drain cleanout information through a mobile application that interacts with the RFID tag 300, the RFID reader 320, or another device on the network interface 360. For example, the user A can receive an alert on their mobile device when maintenance is required.

Referring to FIG. 5, the disclosure also relates to a method for using the sewer cleanout cap 100. The method includes generating an energizing signal E for the RFID tag 300, receiving the return signal R from RFID tag 300, and determining a maintenance action based on the return signal R.

Initially at step 702, the RFID reader 320 generates the energizing signal E for the RFID tag 300. For example, if the user A is in close proximity to the sewer cleanout cap 100, the user A can use the RFID reader 320 to scan the RFID tag 300, generating the energizing signal E that energizes the RFID tag 300. In aspects, the window 210 can have an ID code etched in the glass, for scanning by a reader.

At step 704, the RFID reader 320 receives the return signal R from the RFID tag 300. The return signal R generally includes the UID related to the RFID tag 300. The UID is a smart label encoding digital data. For example, the UID can be derived from a serial number, a date and/or time of production, an inventory number, a batch number, a model number, or a binary code related to the sewer cleanout cap 100. UID retrieval can be used to identify a particular instance of a sewer cleanout cap 100. For example, when recall is announced, the user A can scan the UID for the batch number to determine whether the sewer cleanout cap 100 is defective and/or whether a replacement is needed. The UID is generally linked to a database entry in the database 350 of the RFID reader 320. The database 350 can use the UID to obtain additional information relating to the sewer drain cleanout 10, including: installation date(s) of the sewer cleanout cap 100, cleanout and maintenance history, and/or a location of the sewer drain cleanout 10. This information can be transmitted to the display 322 on the RFID reader 320. The RFID reader 320 can be configured to modify the displayed information and/or enter additional information. Where the UID is not permanently burned into the RFID tag 300, the RFID reader 320 can be configured to reprogram the UID of the RFID tag 300 and/or additional information stored thereon. For example, if a sewer cleanout cap 100 is replaced, the RFID tag 300 can be repurposed and modified for a new sewer cleanout cap 100. The RFID tag 300 can also be encrypted for security purposes.

At step 706, the user A can determine whether to perform a maintenance action, and/or which specific maintenance action to perform, based on information from the database 350 displayed on the RFID reader 320 following the return signal R. For example, the user A can observe a potential clog through the window 110 and review the cleanout and maintenance history of the sewer drain cleanout 10. After reviewing the cleanout and maintenance history, the user can determine any required maintenance, such as removing sewage or snaking a clogged pipe in the sewer drain cleanout 10.

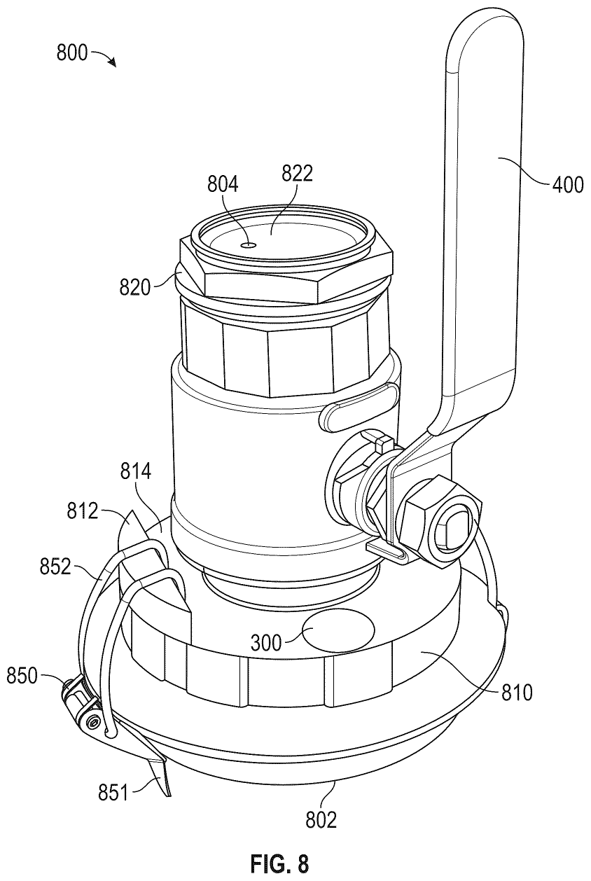

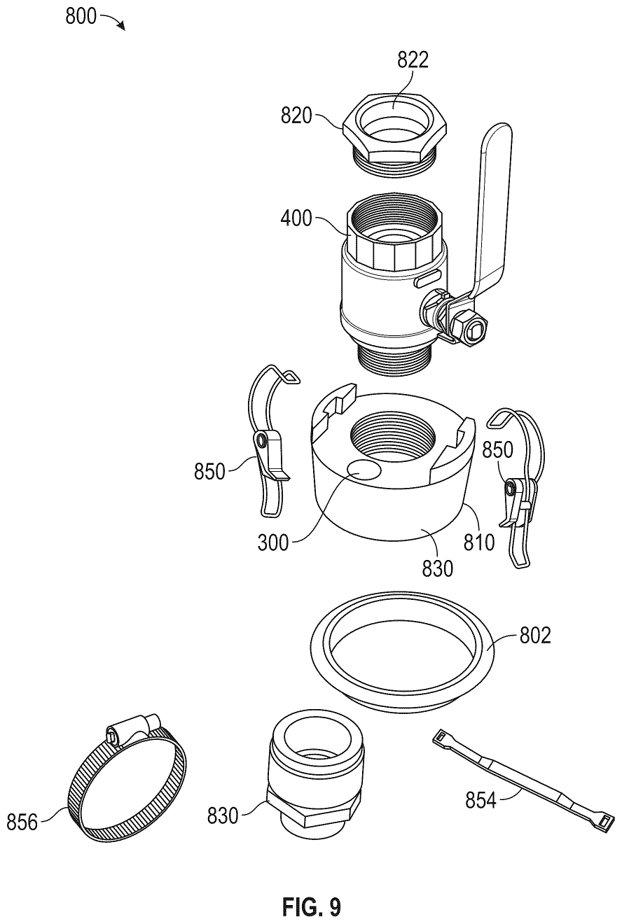

Referring to FIGS. 8-10, another example embodiment of the sewer cleanout cap 800 of this disclosure includes a body portion 810 and a window plug 820, and an RFID tag 300 and/or a Near Field Communication (NFC) tag 804. In aspects, the sewer cleanout cap 800 can include a ball valve 400 disposed in the body portion 810, which is configured to receive either the window plug 820 or a PVC shop hose adapter 830 (FIG. 9).

The window plug 820 includes a site glass 822 configured to enable visibility into the sewer drain cleanout 1010. The body (e.g., rim) of the window plug 820 can be formed from aluminum, stainless steel and/or other suitable corrosion-resistant materials. The exterior of the window plug 820 can include hexagonal sides configured to be gripped by a standard plumber's wrench for ease of installation and removal. The window plug 820 includes external threads configured to engage complementary internal threads formed in either the ball valve 400 or the body portion 810 of the sewer cleanout cap 800. In certain aspects, the threaded engagement can be supplemented with a gasket, such as a rubber, silicone, or elastomeric gasket, positioned between the window plug 820 and the mating surface of the ball valve 400 or the body portion 810 to provide a watertight seal. Alternatively, a sealing compound or thread sealant can be applied to the threads of the window plug 820 to prevent leakage during operation. When installed, the site glass 822 provides a transparent viewing port for visual assessment of sewer drainage conditions without removing the sewer cleanout cap 800. The inclusion of the window plug 820 with site glass 822 can reduce the need for unnecessary cap removal, thereby decreasing the risk of contamination, minimizing wastewater release, and improving inspection efficiency, which provides both technical performance advantages and environmental benefits. The site glass 822 may be made of glass, plexiglass, and/or other transparent materials.

The body portion 810 of the sewer cleanout cap can be produced in multiple variations to accommodate different installation environments. The body portion 810 can be tapered or straight, and can be configured as threaded or unthreaded, thereby allowing compatibility with a variety of sewer pipe geometries and connection requirements. Raised engagement surfaces can be incorporated into the body portion 810 to allow the user to apply impact force, for example with a hammer, to seat or remove the cap. In some variations, the raised surfaces can be formed as partial arcs or half-moon shapes on the exterior of the cap body to provide consistent tool engagement. A recessed version of the cap can also be implemented for below-ground or under-slab applications, in which the cap is positioned internally within a pipe riser rather than protruding above the pipe. The recessed version can include a site glass for inspection, and when removal of excess water or material is required, the site glass can be removed and a ball valve installed in its place to permit controlled extraction of sewage or debris.

In an illustrative example, the window plug 820 is removed from the body portion 810 of the sewer cleanout cap 800 to allow direct access into the sewer drain cleanout 1010. The technician rotates the window plug 820 counterclockwise to disengage the threaded engagement with the opening in the body portion 810. Once removed, a vacuum adapter 830 is inserted into the same opening. The vacuum adapter 830 is configured to couple to a standard shop vacuum hose (not shown), enabling the technician to apply suction directly to the interior of the sewer drain cleanout 1010 for the purpose of extracting standing water, debris, or other obstructions. This configuration allows cleaning or preparation of the line without fully removing the sewer cleanout cap 800, thereby reducing the potential for sewage spillage and minimizing handling of the clamp assemblies 850. After the vacuum operation is complete, the vacuum adapter 830 is removed, and the window plug 820 is reinstalled to restore the sealed, transparent inspection capability of the sewer cleanout cap 800. Clamp 856 (FIG. 9) may be used to secure the clamp assemblies 850 to the sewer drain cleanout 1010 in the case where there is not free and open access to the entire cleanout pipe/body and securement straps 854 cannot be deployed.

In further aspects, the sewer cleanout cap 800 can integrate a variety of wireless identification and communication technologies for tracking, authentication, and environmental sensing. An RFID tag can be used for storing cap manufacturing information such as production batch, lot number, or installation reference. An NFC tag can be used to authenticate cap manufacturing information and allow an end user to securely enter additional data into a remote database or portal, such as installation date, installer information, service provider details, or maintenance notes. The sewer cleanout cap 800 can also include sensory modules such as water level sensors, gas detectors, or flow monitors. Data from these sensors can be communicated externally by a wireless communication interface that can include one or more technologies such as Bluetooth, Bluetooth Low Energy (BLE), Zigbee, LoRa, LoRaWAN, cellular, NFC, or Wi-Fi. In certain implementations, a receiver module can be incorporated into the cap to collect sensory data and either process it locally or transmit it through an existing external module to a remote recipient, thereby providing advance warning of sewer backups or hazardous conditions while reducing the likelihood of sewage overflow. The sensor can be located within the interior of the body portion 810 of the sewer cleanout cap 800, mounted near the site glass 822, or positioned adjacent to the valve 400 so that it is in direct communication with the fluid or gas within the sewer drain cleanout 1010. In certain aspects, the sensor can be embedded into the window plug 820 or secured along the inner wall of the body portion 810 to minimize obstruction of flow. Power for the sensor can be supplied through a small integrated battery, a rechargeable energy storage element, or by energy harvesting methods such as inductive coupling, piezoelectric vibration, or thermoelectric conversion from temperature differences in the sewer environment. In configurations where the wireless identification tag includes an RFID or NFC element, the sensor can be energized intermittently through the same energizing signal used to activate the tag, thereby reducing power demands. The sensor output can be processed locally by a microcontroller embedded within the cap or transmitted directly via a wireless communication module to an external device for monitoring and analysis.

In an illustrative example, a sewer cleanout cap 800 can include a water level sensor positioned within the body portion 810 and configured to detect rising liquid levels inside the sewer drain cleanout 1010. When the sensor detects that the liquid level has exceeded a predetermined threshold, the sensor generates a signal that is transmitted through the wireless identification tag or a separate wireless communication module, such as Bluetooth, LoRa, or Wi-Fi, to a remote receiver or mobile device. The transmitted information can notify the system owner or maintenance personnel of a potential backup condition before sewage reaches the surface, allowing preventative action such as opening the ball valve 400 or attaching the vacuum adapter to extract excess water. By providing early warning of abnormal sewer conditions, the sensor system enhances technical performance, reduces the risk of sewage overflow, and improves environmental safety.

The RFID tag 300 is configured to interact with an RFID reader 320 (FIG. 1), which can be controlled by a user. The NFC tag 804 is configured to interact with an NFC reader (not shown), which can be controlled by a user. It is contemplated that any combination of the RFID tag 300 and/or the NFC tag 804 can be used. Either can be located in any suitable location on the body portion 810 of the sewer cleanout cap 800, on the window plug 820, and/or site glass 822. It is contemplated that features of the sewer cleanout cap 800 can be used with the sewer cleanout cap 100 and vice versa. The RFID tag 300 and/or the NFC tag 804 are each configured to transmit a return signal when energized.

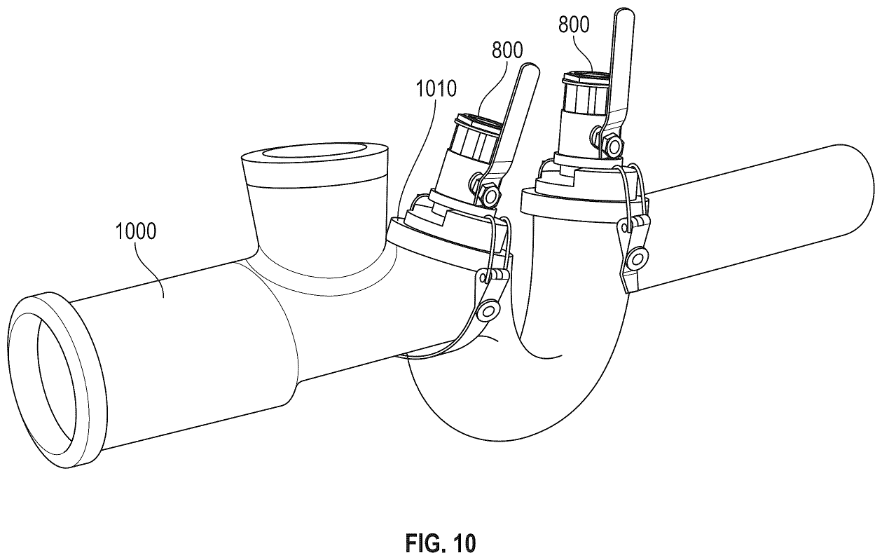

The body portion 810 of the sewer cleanout cap 800 includes two or more fingers 812 that are configured for securing the sewer cleanout cap 800 to a sewer drain cleanout (e.g., “trap”) 1010 (FIG. 10) of a pipe 1000, by affixing two or more of clamp 850 to finger 812. Each finger 812 can be located on an opposing end of surface 814 of body portion 810. Clamp 850 can be a “toggle” style clamp.

The clamp assembly 850 is a toggle-style fastening mechanism configured to releasably secure the body portion 810 of the sewer cleanout cap 800 to the sewer drain cleanout 1010 (FIG. 10). Each clamp 850 includes a pivoting handle lever 851 connected to a finger 812, the finger 812 functioning as a latch link in one example. The pivoting handle lever 851 is joined to the finger 812 by a hinge pin to enable manual actuation between a locked position and an unlocked position. A strap 854 extends between opposing clamps 850 to apply compressive force across the body portion 810 when the clamps are actuated to the locked position, thereby compressing a gasket 802 positioned between the body portion 810 and the sewer drain cleanout 1010 to create a watertight seal. The toggle configuration provides mechanical advantage for creating a tight, vibration-resistant connection while allowing quick release without tools. The clamp components can be formed from stainless steel or other corrosion-resistant materials to withstand exposure to moisture and sewage environments. For example, a first clamp 850 can secure to a first finger 812 and have strap 854 tie to second clamp 850, which can secure to a second finger 812 on an opposing portion of surface 814.

In an illustrative example, the clamp assemblies 850 are used to secure the body portion 810 of the sewer cleanout cap 800 to the sewer drain cleanout 1010 during routine maintenance. The body portion 810 is positioned over the sewer drain cleanout 1010 with the gasket 802 aligned between the mating surfaces. Each clamp 850, including the pivoting handle lever 851 and the finger 812, is then actuated to the locked position, causing the strap 854 to draw the clamps toward one another and apply compressive force across the body portion 810. This compression seals the gasket 802 and prevents leakage of fluids or gases during sewer operation.

When maintenance access is required, the technician unlocks the clamp assemblies 850 by rotating the pivoting handle levers 851 to the unlocked position. This releases the tension in the strap 854 and allows the body portion 810 to be lifted from the sewer drain cleanout 1010 without the need for specialized tools. The toggle-style configuration of the clamps 850 provides both a secure, vibration-resistant hold during operation and quick-release capability for rapid access, making the system suitable for environments where frequent inspections or interventions are necessary.

The body portion 810 of the sewer cleanout cap 800 is generally made from stainless steel, however, other suitable materials are contemplated. For example, the body portion 810 can be made from metals such as cast iron, plastic, composites, and/or alternative durable materials. The body portion 810 can be treated with a corrosion-resistant coating to prevent rusting, such as plasma electrolytic oxidation, chromate conversion coating, painting, or a powder coating. While illustrated with a circular shape, the body portion 810 can include any suitable shape. The body portion 810 supports RFID tag 300 and/or NFC tag 804 thereon. The body portion 810 can include threads (or ribs) formed in an outer rim 830 to enable secure attachment and/or removal from the sewer drain cleanout 1010. It is contemplated that the body portion 810 can be secured to sewer drain cleanout 1010 by any suitable attachment technique (e.g., snap-fit, friction-fit, fastening, adhesion, etc.). In aspects, the body portion 810 can be secured to the sewer drain cleanout 1010 by gasket 802. Gasket 802 can be made from any suitable material. Alternatively, the body portion 810 can be secured to the sewer drain cleanout 1010 by adding a sealant, for example, wax (or RTV), around the outer rim 830 for providing a watertight seal.

In an illustrative example in which only the RFID tag 300 is present on the sewer cleanout cap 800, a maintenance technician approaching the sewer drain cleanout 1010 can use an RFID reader 320 to wirelessly energize the RFID tag 300 and receive a return signal containing a unique identifier. The RFID reader 320 can then retrieve from a database the cleanout and maintenance history, installation date, and location information associated with the sewer drain cleanout 1010. This process enables the technician to determine whether a cleaning or inspection is required without physically opening the sewer cleanout cap 800. The RFID configuration is particularly suited for scanning from a short distance, including through debris or when the sewer cleanout cap 800 is partially obstructed from view.

In an example in which only the NFC tag 804 is present on the sewer cleanout cap 800, a user can approach the sewer drain cleanout 1010 with an NFC-enabled mobile device and tap or hold the device near the NFC tag 804. The NFC interface can instantly launch a dedicated application or web portal containing the sewer cleanout's maintenance records, real-time inspection checklists, or instructional materials. This configuration is advantageous for field personnel who carry smartphones or tablets but do not have a dedicated RFID reader. NFC interaction also allows quick data entry directly at the point of service, such as logging a completed maintenance action or updating the condition of the sewer drain cleanout 1010.

In an example in which both the RFID tag 300 and NFC tag 804 are present on the sewer cleanout cap 800, each can serve complementary functions. A technician equipped with an RFID reader 320 can scan the RFID tag 300 from a distance to perform initial identification and status retrieval before arriving at the sewer drain cleanout 1010, allowing prioritization of service routes. Upon arrival, the technician can then use an NFC-enabled device to interact with the NFC tag 804 for high-speed data updates, adding photographic evidence of the inspection, and confirming service completion in real time. This combined configuration enables flexible operation across different work environments and device capabilities, ensuring both remote status checks and on-site data management are possible.

In some implementations, the sewer cleanout cap may include only an NFC tag without an RFID tag. This configuration may be selected for installations where service personnel primarily use NFC-enabled mobile devices rather than dedicated RFID readers, allowing the tag to be accessed by simply bringing a smartphone or tablet into close proximity. The NFC tag may store data sets intended for rapid, on-site retrieval and update, such as a current maintenance checklist, technician notes, or service instructions in a web-link format. Conversely, some installations may include only an RFID tag without an NFC tag, such as in cases where long-range scanning is beneficial, for example, to identify multiple sewer cleanout caps along a line without physically approaching each unit. The RFID tag may store a unique identifier linked to a secure database record containing installation date, maintenance history, or GIS location data, which can be accessed from a central office before sending personnel into the field. In certain cases, the same system may include both NFC and RFID tags, with the RFID tag enabling remote status checks and asset tracking while the NFC tag enables quick, in-person updates and retrieval of detailed, localized information.

In other aspects of the present disclosure, the wireless identification tag may be implemented using alternative wireless communication technologies in place of or in addition to RFID and NFC. The wireless identification tag may include a Wi-Fi transceiver configured to provide longer-range, high-bandwidth connectivity for transmitting maintenance records, sensor data, or inspection video streams to a remote device or server. The wireless identification tag may include a Bluetooth or Bluetooth Low Energy (BLE) module configured to pair with a smartphone, tablet, or dedicated service device for short-range, energy-efficient data exchange. In further aspects, the wireless identification tag may include a LoRa or other low-power wide-area network (LPWAN) radio configured for long-range, low-power communication suitable for periodic status updates from remote or infrequently accessed sewer locations. The wireless identification tag may include a Zigbee or similar mesh networking transceiver configured to allow multiple sewer cleanout caps and related infrastructure devices to relay information through a mesh network to a central node. In yet other aspects, the wireless identification tag may include an ultra-wideband (UWB) transceiver configured to provide high-precision ranging and positioning capabilities for locating a buried or obstructed sewer cleanout cap.

FIG. 10 illustrates an example configuration in which two sewer cleanout caps 800 are secured to two sewer drain cleanouts 1010, such as cleanouts provided at opposite ends of a trap, of a pipe 1000. Each sewer cleanout cap 800 is retained on the corresponding sewer drain cleanout 1010 using a pair of toggle clamps, such as a first toggle clamp 850 and a second toggle clamp 852, with a strap 854 extending between the toggle clamps to apply compressive force across the body portion 810 of the sewer cleanout cap 800. The clamp and strap arrangement provides a releasable yet secure connection that maintains a sealed interface between the body portion 810 and the sewer drain cleanout 1010 during operation. The straps 854 can be tightened via actuation of the pivoting handle levers 851 of the toggle clamps, which in turn compress a gasket 802 positioned between the body portion 810 and the sewer drain cleanout 1010 to form a watertight seal. This arrangement allows for quick removal of either sewer cleanout cap 800 for maintenance or inspection while maintaining a secure, sealed connection during normal use.

The use of two sewer cleanout caps 800 on opposite ends of the trap portion of the pipe 1000 can provide multiple operational benefits. The dual-cap arrangement allows service personnel to perform directional cleaning by opening one cleanout cap 800 while applying water pressure, compressed air, or vacuum suction through the other, thereby improving debris removal efficiency. This configuration can also facilitate quicker inspection, as visual assessment or camera insertion can be performed from either end of the trap to pinpoint blockages or verify cleaning effectiveness. Additionally, by maintaining a sealed interface at both ends using the clamp and strap assemblies with gaskets 802, the system can reduce the likelihood of wastewater leakage during normal operation, contributing to improved environmental protection and reduced contamination risks.

It should be understood that the foregoing description is only illustrative of the present disclosure. Various alternatives, modifications, and variances can be devised by those skilled in the art without departing from the disclosure. For instance, although certain aspects herein are described as separate aspects, each of the aspects herein can be combined with one or more of the other aspects herein. Specific structural and functional details disclosed herein are not to be interpreted as limiting, but as a basis for the claims and as a representative basis for teaching one skilled in the art to variously employ the present disclosure in any appropriately detailed structure. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A sewer cleanout cap comprising:
a body portion configured to be disposed on a sewer drain cleanout;
a window plug removably coupled to the body portion, the window plug configured to enable a user to check sewer drainage;
at least one wireless identification tag disposed on at least one of the body portion, the window plug, or a site glass of the window plug, the at least one wireless identification tag configured to transmit a return signal when energized; and
at least one clamp assembly coupled to the body portion and configured to releasably secure the body portion to the sewer drain cleanout.

2. The sewer cleanout cap of claim 1, wherein the at least one wireless identification tag comprises a radio frequency identification (RFID) tag, a near field communication (NFC) tag, or a combination of a radio frequency identification tag and a near field communication tag.

3. The sewer cleanout cap of claim 1, wherein the body portion includes at least two fingers configured to engage the at least one clamp assembly.

4. The sewer cleanout cap of claim 1, wherein the at least one clamp assembly includes a first toggle clamp and a second toggle clamp and further comprises a strap extending between the first toggle clamp and the second toggle clamp to apply compressive force across the body portion.

5. The sewer cleanout cap of claim 4, wherein each of the first toggle clamp and the second toggle clamp comprises a pivoting handle lever connected to one of the at least two fingers.

6. The sewer cleanout cap of claim 5, further comprising a gasket positioned between the body portion and the sewer drain cleanout.

7. The sewer cleanout cap of claim 6, wherein actuation of the pivoting handle lever to a locked position is configured to compress the gasket to form a watertight seal.

8. The sewer cleanout cap of claim 1, further comprising a gasket positioned between the body portion and the sewer drain cleanout to form a seal when the body portion is secured by the at least one clamp assembly or when the body portion is secured by an alternative attachment mechanism selected from threaded engagement, snap-fit engagement, friction-fit engagement, or adhesive bonding.

9. The sewer cleanout cap of claim 1, wherein the window plug is removable from the body portion and replaceable with a vacuum adapter configured to couple to a vacuum hose for extracting material from the sewer drain cleanout.

10. The sewer cleanout cap of claim 9, wherein the body portion is configured to support the vacuum adapter without removal of the body portion from the sewer drain cleanout.

11. The sewer cleanout cap of claim 2, wherein at least one of the RFID tag or the NFC tag stores a unique identifier (UID), the UID enabling access to information relating to the sewer drain cleanout.

12. The sewer cleanout cap of claim 11, wherein the information relating to the sewer drain cleanout includes an installation date of the sewer cleanout cap, a cleanout and maintenance history, and/or a location.

13. The sewer cleanout cap of claim 1, further comprising a valve disposed in the body portion.

14. The sewer cleanout cap of claim 1, wherein the site glass is configured to enable visibility and/or access into the sewer drain cleanout.

15. A computer-implemented method for using a sewer cleanout cap comprising:
generating an energizing signal for a wireless identification tag, the wireless identification tag disposed on a body portion of the sewer cleanout cap, wherein the sewer cleanout cap is coupled to a sewer drain cleanout;
receiving a return signal from the wireless identification tag by a wireless identification tag reader; and
determining a maintenance action for a sewer drain cleanout based on the return signal.

16. The computer-implemented method of claim 15, wherein the wireless identification tag stores a unique identifier (UID), the UID enabling access to information relating to a sewer drain cleanout.

17. The computer-implemented method of claim 16, wherein the information relating to the sewer drain cleanout includes an installation date of the sewer cleanout cap, a cleanout and maintenance history, and/or a location.

18. The computer-implemented method of claim 16, further comprising:
reprogramming the UID of the wireless identification tag.

19. The computer-implemented method of claim 18, further comprising:
transmitting information to a display of the wireless identification tag reader to display information relating to the wireless identification tag; and
modifying the displayed information via the wireless identification tag reader.

20. The computer-implemented method of claim 19, wherein the wireless identification tag reader is a mobile device.
